(19) United States
(12) Patent Application Publication
(10) Pub. No.: US 2019/0107258 A1
(43) Pub. Date: Apr. 11, 2019

(54) Dimmable LED Tube

(71) Applicants: AMPCO PRODUCTS LTD., Hong Kong (HK); KEYSTONE TECHNOLOGIES LLC, North Wales, PA (US)

(72) Inventor: Chun Tung LO, Hong Kong (HK)

(21) Appl. No.: 16/127,359

(22) Filed: Sep. 11, 2018

(30) Foreign Application Priority Data
Oct. 10, 2017 (CN) 201721298211.3

(51) Int. Cl. F21K 9/278; F21K 9/272; F21V 23/06; F21V 23/00

(52) U.S. Cl. CPC F21K 9/278; F21K 9/272; H05B 33/0845; F21V 23/003; F21V 23/06

(57) ABSTRACT

A light emitting diode (LED) tube supporting dimming by a low voltage dimmer for replacing a conventional fluorescent lamp is disclosed. The LED tube comprises a tube body, two end caps, four pins, as well as a dimmable LED driver and one or more LEDs in the tube body wherein the LEDs are connected to the dimmable LED driver and driven by the dimmable LED driver. Two of the four pins are used for receiving power input from an AC power supply, and the other two of the four pins are used for receiving dimming control signals from a low-voltage dimmer. The tube body is a hollow cylindrical tube with the same mechanical structure of a conventional fluorescent lamp.

### CROSS-REFERENCE TO RELATED APPLICATION

This application claims priority to Chinese Utility Model Application No. 201721298211.3, filed in the State Intellectual Property Office of China on Oct. 10, 2017, the entirety of which is incorporated herein by reference.

### FIELD OF THE INVENTION

The present invention relates generally to an LED tube. In particular, the present invention relates to a dimmable LED tube using a conventional mechanical structure of a straight tube.

### BACKGROUND

Conventionally, fluorescent lamps make use of low-pressure mercury vapors and phosphors to emit visible light. To properly start and run, fluorescent bulbs must have some basic components such as cathodes (sometimes called filament heaters or emitters) at each end of the fluorescent arc (which is usually the ends of the glass tubes regardless of shape). These cathodes must be heated properly for operation and as such, have two electrical connection point (pins) at each end of the fluorescent arc tube for a total of 4 connection points. Fluorescent lamp applications generally include tubes, ballasts, starters, lamp stands, lamp holders, etc. Fluorescent lamp types include straight tubes (usually called double ended tubes), circular lamps, and various compact lamps (single ended bulbs) and so on. Straight tubes are usually identified as a T5, T8, T10, T12, etc. which is related to the tube diameter. The combination of “T+ number” represents the tube diameter, where one T=⅛ inch (3.175 mm), and the number represents the number of Ts, for example, T12 is ⅛″*12=1.25 inches or =25.4 mm*⅛*12=38 mm.

Fluorescent lamps have a higher luminous efficiency than traditional light bulbs (incandescent lamps), but at a slightly higher cost than incandescent lamps. In addition, the production and recycling of fluorescent lamps are accompanied by environmental problems such as heavy metal contamination. The major concern is the mercury, which is a significant toxic pollutant. This shows, that while offering major efficiency improvements over incandescent technology, there is still a lot of ways to further improve over fluorescent light technology.

Light emitting diode (LED) lamps have an advantage over fluorescent lamps that they do not contain mercury while achieving even further improvements in efficiency and controlling the driving energy required for emitting light effectively. The design of LEDs is well established and principally includes an LED light source and a driver circuit. The LED light source may include one or more LEDs or LED strings. The LED driver circuit is an electrical device (which may be a separate device or embedded into the LED lamp) for converting mains power (such as AC Mains power supply, 120-277V AC) into a specific voltage and current to properly drive the LED light source for emitting light. Generally, the input of the LED driver may consist of a high-voltage industrial frequency AC (i.e., mains power of 120 v, 208 v, 230 v, 277 v as well as others), low-voltage DC (usually 12 v or 24 v but as high as 60 v), high-voltage DC, low-voltage high-frequency AC (such as the output of an electronic transformer), etc. AC Mains power (for example, 120-277V AC) is connected to the LED driver, and the driver outputs appropriate voltage and current to drive the LED light source.

With the development of technologies for the reduction of energy consumption, LED lamps have taken the lead in new product introduction as they have the advantage of luminous efficacy and energy savings which are very environmentally friendly. LED light sources are, therefore, gradually replacing conventional incandescent and all types of fluorescent lamps. The LED lamps can be made into a very cost-advantageous upgrade and alternative solution, by putting the LED light source and its associated driver circuit, into the existing fluorescent lamp tubes and attachment housing (end caps for double ended lamps and the base or pin holder for what are known as single ended lamps). This allows the LED replacement lamps to make use of the existing lamp stands, sockets and holders in existing fixtures. These LED based light sources are made in accordance with specific standards and specifications (such as T8 model under the ANSI C78.81 double ended lamp standard and ANSI C78.901 for single ended lamps), such that the LED tubes made to these standards and specifications can be easily incorporated into existing fluorescent lighting systems for upgrade with minimum transformation, except for the obvious necessity of removing the old fluorescent bulbs. Other electronic components for the old fluorescent bulbs, such as ballasts, starters, etc., may be left in place but electrically disconnected.

Due to the size constraints inside of the fluorescent configurations and the limited electrical connectivity to these lamps, most of the current commercially available designs of LED tubes, for example the T8 types, do not have a dimming function. Of those that are dimmable, most use a dimming scheme known as “triac dimming” or “front phase dimming”. In this case, the AC Mains power is connected directly to the dimmer and then to the line input of the LED tube. (The neutral line is also connected to the dimmable LED tube to complete the circuit.) For example, in the case of a triac dimmer (there are other technologies available such as FET phase control dimmers, reverse phase control, ELV and others), the output of the dimmer is connected to the LED tube's driver circuit which is subsequently connected to drive the LED light source. The main note here is that in this dimming scheme, only two wires are required for both the tube power and the dimming function (phase control dimmer output hot and neutral).

In the lighting industry today, there are other commonly adopted dimming schemes such as “low voltage dimming”, “electronic low voltage (ELV) dimming”, “1-10V dimming”, “0-10V dimming”, “DALI or any other digital signal scheme. Since they are widely adopted, it would also be very desirable for LED replacement lamps to be operable and controllable from them. In these dimming schemes, the dimming signal or control signal is placed on a separated pair of wires from the AC Mains power. Products utilizing these dimming methods therefor, have two groups of electrical connections, a first group is used for supplying power to the dimmable device (LED tube), and the second group being the low voltage control circuit, which communicates the dimming level to the lighting device (such as an LED tube driver circuit). This dimming control through separate control wires in current fluorescent technology is accomplished through the use of ballasts with added connections (wires) for the control signal and, here to for, not readily available for LED fluorescent replacement lamps. In installations with this type of industrial and technological upgrade, the separated pair of dedicated control lines is routed to every light source so that the dimming control signal can simultaneously control all of the lamps. It should be noted that, when compared to the AC dimming (phase control) described above, the low-voltage or digital control signal requires the additional connections to attach or connect the control signal for the control signal on every light source. In the few currently commercially available LED replacement lamps, which can be controlled by a separate control signal, the additional connections are made through holes introduced into the LED tube body, end caps or base of the LED lamp with “flying leads” or loose wires. These holes require additional operations and processing during the manufacture of the tube, which increases the cost. Additionally, reliability may be also reduced due to the potential for leaks and ingression of unwanted environmental elements such as water into these additional “holes”.

In order to solve the above problems, this invention proposes a new LED tube, which has control signal connections for the dimming function without modification of the LED lamp construction from the standard and ANSI specifications noted above.

### SUMMARY OF THE INVENTION

In accordance with various embodiments of the present disclosure, an LED replacement lamp supporting dimming by a separate control signal is disclosed. The LED replacement lamp for replacing a conventional double ended fluorescent lamp, the LED replacement lamp comprises: a tube body for housing the one or more LEDs or LED “strings”, two end caps, a dimmable LED driver circuit implemented by an internal circuit capable of responding to a separated control signal such as “low voltage dimming”, “electronic low voltage (ELV) dimming”, “1-10V dimming”, “0-10V dimming”, “DALI” or any other digital signal scheme and four pins as were connected to the fluorescent cathodes and lamp arc tube ends. The one or more LEDs or LED “strings” are driven by the dimmable LED driver circuit, wherein the two end caps comprise a first end cap and a second end cap for covering the tube body at the two ends respectively, with the dimmable LED driver circuit located in the tube body, four pins fixed on the two end caps and electrically connected to the dimmable LED driver circuit, and the one or more LEDs located inside the tube body and connected to the dimmable LED driver circuit.

In accordance with a further aspect of the present disclosure, the four pins comprise a first pin and a second pin for receiving power input from an AC power supply, and a third pin and a fourth pin for receiving one or more dimming control signals. The one or more LEDs are driven by the dimmable LED driver circuit.

In accordance with a further aspect of the present disclosure, the first pin and the second pin are on the first end cap, the third pin and the fourth pin are on the second end cap.

In accordance with a further aspect of the present disclosure, the first pin and third pin are on the first end cap, and the second pin and the fourth pin are on the second end cap.

In accordance with a further aspect of the present disclosure, the LED tube conforms to an ANSI C78 standard for all fluorescent lamp sizes and physical dimensions.

In accordance with a further aspect of the present disclosure, the LED tube is a T2, T3.5, T4, T5, T6, T8, T9, T10 or T12 tube of any shape, bend or circular configuration.

In accordance with a further aspect of the present disclosure, the tube body is a tube, glass plastic or other, with a mechanical structure of a fluorescent lamp.

In accordance with a further aspect of the present disclosure, an LED lighting system is disclosed. The LED lighting system comprises the LED replacement lamp according to the present disclosure, two sockets, and a dimming controller, configured to provide the one or more dimming control signals to the LED replacement lamp for controlling the one or more LEDs.

In accordance with a further aspect of the present disclosure, the one or more dimming control signals of the dimming controller are connected to the third pin and the fourth pin of the LED replacement lamp

In accordance with a further aspect of the present disclosure, the one or more dimming control signals of the dimming controller are connected to the third pin and the fourth pin through the two sockets.

In accordance with a further aspect of the present disclosure, all sockets conform to the ANSI C82.62 standard.

In accordance with a further aspect of the present disclosure, the dimming controller is a “low voltage dimmer”, “electronic low voltage dimmer”, “1-10V dimmer”, “0-10V dimmer”, “DALI or any other digital signal dimmer.

Yet another aspect of the present disclosure is to provide an LED replacement bulb for replacing a conventional single-ended bulb. The LED replacement bulb comprises: a main body for housing the one or more LEDs or LED “strings”, a lamp base, a dimmable LED driver circuit implemented by an internal circuit capable of responding to a separated control signal such as “low voltage dimming”, “electronic low voltage (ELV) dimming”, “1-10V dimming”, “0-10V dimming”, “DALI” or any other digital signal scheme and four pins as were connected to the fluorescent cathodes and lamp arc tube ends. The LEDs or LED “strings” are driven by the dimmable LED driver circuit, wherein the lamp base is for covering the tube body and the dimmable LED driver circuit. The four pins fixed on the lamp base and electrically connected to the dimmable LED driver circuit, and the one or more LEDs located inside the main body and connected to the dimmable LED driver circuit.

In accordance with a further aspect of the present disclosure, the four pins comprise a first pin and a second pin for receiving power input from an AC power supply, and a third pin and a fourth pin for receiving one or more dimming control signals. The one or more LEDs are driven by the dimmable LED driver circuit.

In accordance with a further aspect of the present disclosure, the LED light bulb is a 2G7 light bulb, a 2GX7 light bulb, a 2G10 LED light bulb, a 2G11 LED light bulb, a GR10q LED square tube, a G10q LED circular tube, a GX10q LED light bulb, a GY10q LED light bulb, a G24q LED light bulb, a GX24q LED light bulb, GX32q LED light bulb, a “2D” bulb or a flat lamp bulb.

In accordance with a further aspect of the present disclosure, the first pin and the second pin are on the left side of the lamp base, the third pin and the fourth pin are on the right side of the lamp base.

In accordance with a further aspect of the present disclosure, the first pin and third pin are on the right side of the lamp base, and the second pin and the fourth pin are on the left side of the lamp base.

In accordance with a further aspect of the present disclosure, an LED lighting system is disclosed. The LED lighting system comprises the LED replacement bulb according to the present disclosure, a socket, and a dimming controller configured to provide the one or more dimming control signals to the LED replacement bulb for controlling the one or more LEDs.

In accordance with a further aspect of the present disclosure, the one or more dimming control signals of the dimming controller are connected to the third pin and the fourth pin or any combination of two of the four total pins.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Other aspects of the present invention are disclosed as illustrated by the embodiments hereinafter.

### BRIEF DESCRIPTION OF THE DRAWINGS

The appended drawings, where like reference numerals refer to identical or functionally similar elements, contain figures of certain embodiments to further illustrate and clarify various aspects, advantages and features of the present invention disclosed herein. It will be appreciated that these drawings depict only certain embodiments of the invention and are not intended to limit its scope. The electrode and the method disclosed herein will be described and explained with additional specificity and detail through the use of the accompanying drawings in which:

The accompanying drawings illustrate embodiments of the present disclosure and, together with the description, serve to explain the principles of the invention.

FIG. 1 depicts a T8 LED tube with two end caps that is compatible with the ANSI C78.81 standard.

FIG. 2 depicts an exemplary fluorescent lighting system including a conventional fluorescent tube.

FIGS. 3A and 3B depict a conventional LED tube.

FIG. 4 depicts an exemplary connection of a low voltage or a 0-10V dimmer to a dimmable LED driver for driving LED.

FIG. 5 depicts a schematic diagram of an exemplary LED lighting system including a 0-10V dimmer.

FIG. 6 depicts an LED tube with a low voltage dimming function according to the prior art.

FIG. 7 depicts a preferred embodiment according to certain embodiments.

FIG. 8 depicts an alternative embodiment according to certain embodiments.

FIGS. 9A and 9B depict the end caps of a T8 LED light tube.

FIG. 10 depicts an exemplarily LED light bulb or LED tube with one end cap and four pins according to certain embodiments.

FIG. 11 depicts the end cap of a 2G7 or a 2GX7 LED light bulb according to certain embodiments.

FIG. 12 depicts the end cap of a 2G10 or a 2G11 LED light bulb according to certain embodiments.

FIG. 13 depicts the end cap of a GR10q LED square tube according to certain embodiments.

FIG. 14 depicts the end cap of a G10q LED circular tube according to certain embodiments.

FIG. 15 depicts the end cap of a GX10q or GY10q LED light bulb according to certain embodiments.

FIG. 16 depicts the end cap of a G24q or GX24q LED light bulb according to certain embodiments.

FIG. 17 depicts the end cap of a GX32q LED light bulb according to certain embodiments.

Skilled artisans will appreciate that elements in the figures are illustrated for simplicity and clarity and have not necessarily been depicted to scale or identified in every detail.

### DETAILED DESCRIPTION OF THE INVENTION

The present disclosure relates generally to an LED replacement lamp. More specifically, but without limitation, the present disclosure relates to a dimmable LED replacement lamp using the conventional mechanical structure of either a double ended or single ended fluorescent lamp and which has a dimmable driver circuit which is controlled by a dimming control signal on a separate pair of connections in addition to the incoming mains power.

In the following detailed description, the system and the apparatus are merely exemplary in nature and are not intended to limit the disclosure or its application and/or uses. It should be appreciated that a vast number of variations exist. The detailed description will enable those of ordinary skill in the art to implement an exemplary embodiment of the present disclosure without undue experimentation, and it is understood that various changes or modifications may be made in the function and arrangement of systems and apparatuses of operation described in the exemplary embodiment without departing from the scope of the present disclosure as set forth in the appended claims.

The following terms are used herein in the specification and appended claims. The articles “a”, “an” and “the” are not intended to denote a limitation of quantity, but rather to denote the presence of at least one of the item being referred to, unless otherwise indicated or clearly contradicted by context. Further, the terms “comprises”, “comprising”, “including” and “having” are intended to be inclusive and mean that there may be additional elements other than the listed elements.

Terms such as “left”, “right”, and variations thereof herein are used for ease of description to explain the positioning of one element with respect to a second element, and are not intended to be limiting to a specific orientation or position.

Terms such as “first”, “second”, “third”, “fourth”, and variations thereof herein are used to describe various elements, regions, sections, etc. and are not intended to be limiting.

Terms such as “connected”, “mounted”, and variations thereof herein are used broadly and encompass direct and indirect connections and mountings; and are not restricted to electrical, physical or mechanical attachments, or mountings.

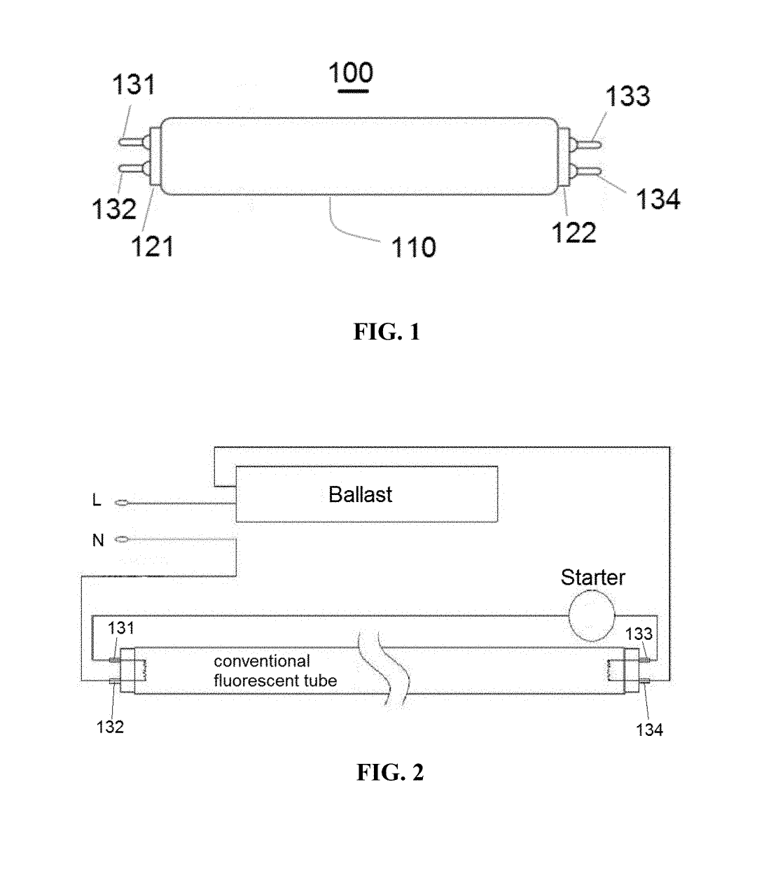

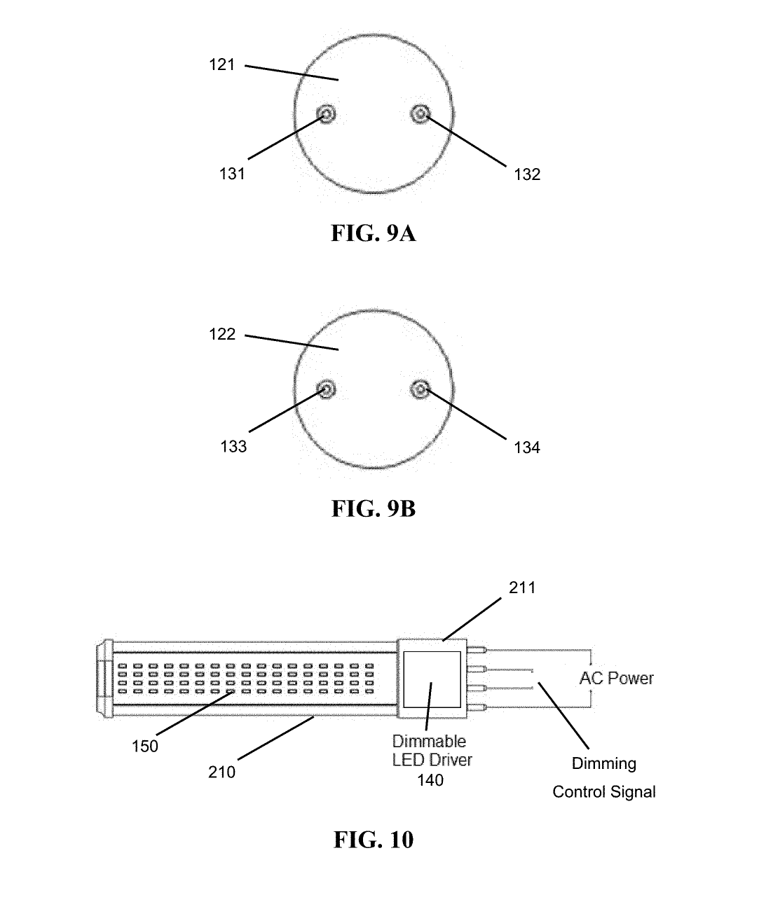

FIG. 1 shows a T8 LED tube 100 with two end caps conforming to the American National Standards Institute (ANSI) C78.81 standard. The LED tube 100 includes a tube body 110, two end caps 121, 122, and four pins 131-134. The tube body 110 is a hollow cylindrical tube, and the end caps 121, 122 are located at both ends of the tube body 110 longitudinally and cover both ends of the tube body 110. The tube body 110 can be made from plastic, glass, acrylic glass, or other materials that allow visible light to pass through. FIGS. 9A and 9B show the front views of the two end caps 121, 122 of a T8 LED tube 100. The pins 131, 132 pass through the first end caps 121 and are fixed thereto, and the pins 133, 134 pass through the second end cap 122 and are fixed thereto. As shown in the following figures, the LED tube 100 includes a dimmable LED driver circuit 140 and LED 150 (for example, one or more LEDs or LED strings). The dimmable LED driver circuit 140 is an internal circuit capable of responding to a separated control signal such as “low voltage dimming”, “electronic low voltage (ELV) dimming”, “1-10V dimming”, “0-10V dimming”, “DALI” or any other digital signal scheme. Two of the four pins 131-134 are connected to an AC power supply (for example, 120-277V) such that power can be supplied to the dimmable LED driver circuit 140 inside the tube body 110, and the dimmable LED driver circuit 140 further drives the LED 150.

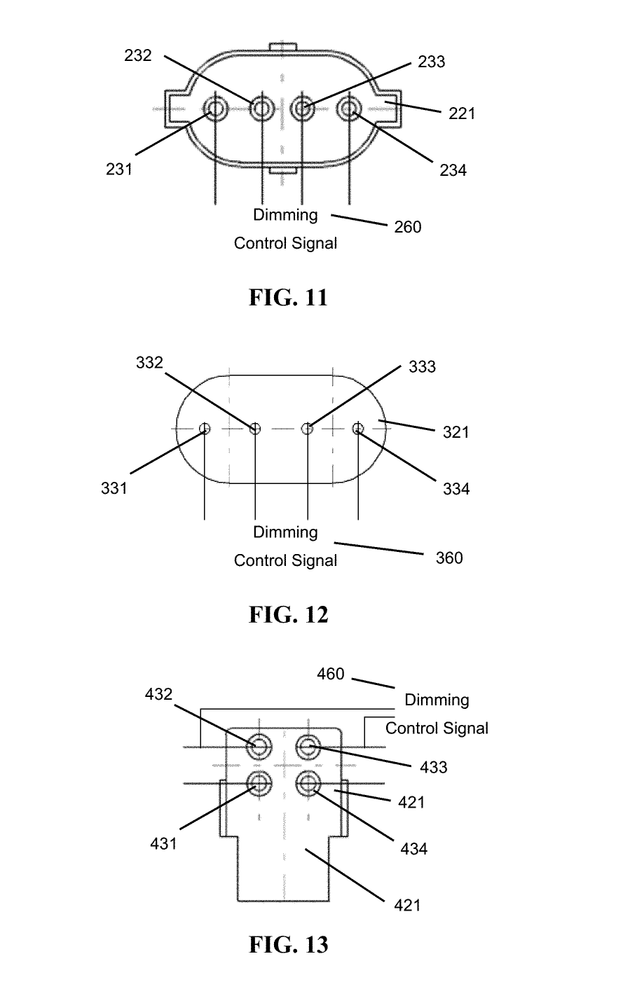

A conventional fluorescent tube connected to an older style magnetic ballast with starter is shown in FIG. 2. In this circuit, the pins 131-134 are actually connected in series in the entire circuit, that is, in addition to a mechanical connection with the socket, all four pins 131-134 are involved in the electrical connection. In this configuration, ballast and starter are essential. There are numerous other fluorescent ballast configurations, both magnetic and electronic in which all have the same feature, the lamp is mechanically supported by the pins and all four of the pins 131-134 have electrical connections. It can be noted that in some instances a lamp base may provide additional mechanical support which is more common for single ended lamp applications. Some examples are depicted in FIGS. 11-17.

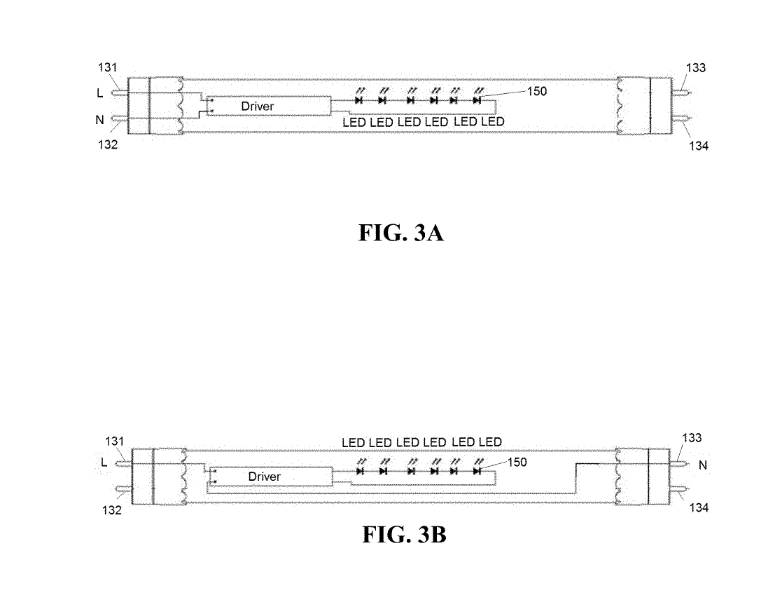

FIGS. 3A and 3B show two of the currently commercially available LED tube configurations. These support only AC Mains power connection function (which could include dimming control only through the mains AC connection such as phase control dimming. As can be seen in FIGS. 3A and 3B, these existing LED lamps have only two pins involved in the AC power connection, while the other two pins are not involved in the electric connection and only provide mechanical connection to the socket. The two pins without electrical connection make the LED lamp mechanically compatible with the existing fluorescent lamp stands and holders. As shown in FIG. 3A, the two pins with electrical connections can be located at the same end of the LED tube 100 on the same end cap. On the other hand, as shown in FIG. 3B, the two pins with electrical connections can be respectively located at two different ends of the LED tube 100 on two different end caps. Specifically, the first conventional system as described in FIG. 3A provides that pin 131 and pin 132 (or pin 133 and pin 134) are used for both mechanical connection and electrical connection, whereas pin 133 and pin 134 (or pin 131 and pin 132) are used for mechanical connection only without electrical connection. The second conventional system as described in FIG. 3B provides that pin 131 (or pin 132) and pin 133 (or pin 134) are used for both mechanical connection and electrical connection, whereas pin 132 (or pin 131) and pin 134 (or pin 133) are used for mechanical connection only without electrical connection. The above pin configuration is preferable and is not intended to be exhaustive. In fact, the configuration may vary depending on the individual applications of the LED lamp. Therefore, it will be apparent to those skilled in the art that such variations may be possible. For example, pin 131 and pin 134 are used for both mechanical connection and electrical connection, whereas pin 132 and 133 are used for mechanical connection only without electrical connection.

This invention advantageously proposes a dimmable LED tube, wherein electrical connection to an external dimming control signal is provided through two of the four pins that are not involved in the LED AC power supply, that is, not connected to the AC power supply. In one embodiment, the dimming control signal, such as “low voltage dimming”, “electronic low voltage (ELV) dimming”, “1-10V dimming”, “0-10V dimming”, “DALI” or any other digital signal scheme, is provided by a dimming controller, which is a low-voltage dimmer, a digital control, a 0-10V dimmer, a part of an energy management or a building management system. For the purpose of simplicity, low-voltage dimmer (or 0-10V dimmer) 160 is used to represent the dimming controller.

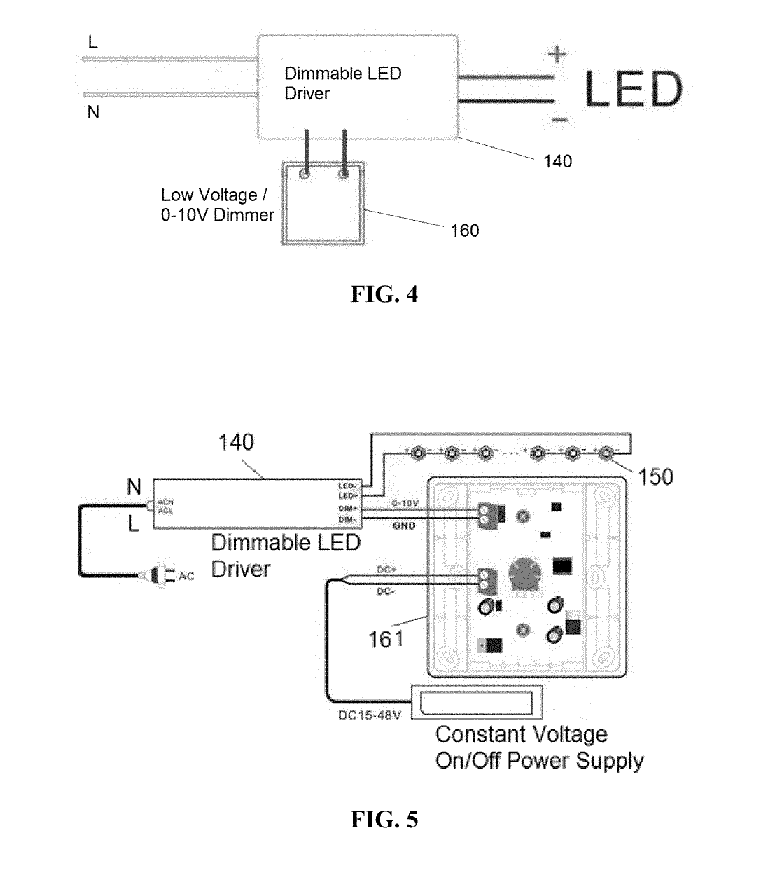

FIGS. 4 and 5 depict two of the many exemplary connections a dimmable driver may have to a dimming control device such as a 0 to 10V dimmer or a more sophisticated lighting control module. FIG. 4 shows an exemplary connection of low-voltage dimmer (or 0-10V dimmer) 160 to a dimmable LED driver circuit 140 for driving LED 150. FIG. 5 is a schematic diagram demonstrating the electrical connection of an exemplary LED lighting system, which includes a dimmable LED driver circuit 140 and a lighting control module 161 which has a 0 to 10V output (but which could be any number of output signal protocols both digital and analog).

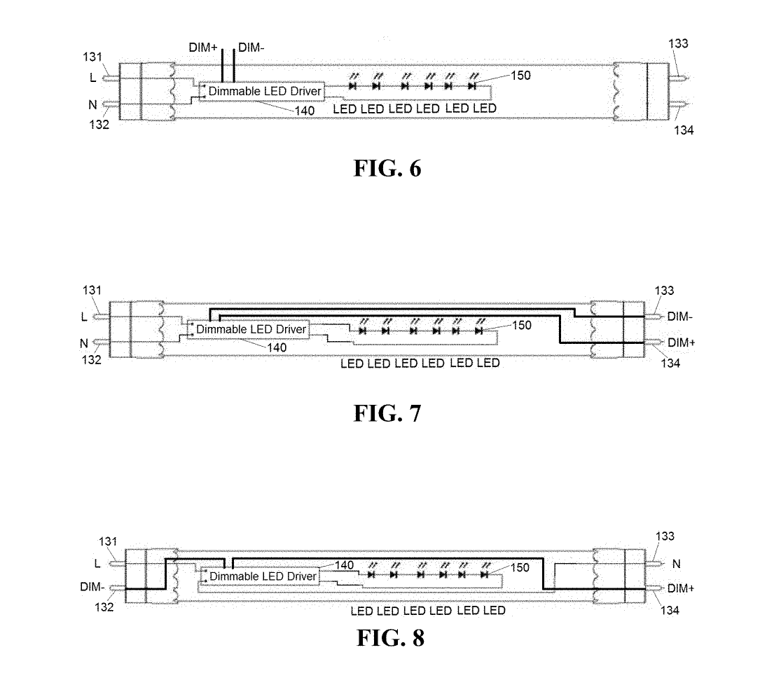

FIG. 6 shows an LED tube 100 supporting low voltage dimming function according to the prior art. In FIG. 6, the additional group of electrical connections to the dimmable LED driver circuit 140 for the dimming control signals (DIM+ and DIM−) is accomplished through additional holes, or access points, in the LED tube body 110 or the end caps 121, 122 of the LED tube 100. The DIM+ and DIM− pins on the LED tube 100 are connected to the dimmable LED driver circuit 140 such that the output control signal or dimming control signal of the low-voltage dimmer (or 0-10V dimmer) 160 received at DIM+ and DIM− pins can be used by the dimmable LED driver circuit 140 to control the brightness or darkness of the LEDs 150.

In accordance with one embodiment of the present disclosure, the dimming control signal DIM+ from the low-voltage dimmer (or 0-10V dimmer) 160 shown in FIG. 4 and FIG. 5, is connected to the DIM+ pin of the dimmable LED driver circuit 140 located in the tube body through one of the pins 131-134 that is not involved in the AC Mains power supply. In certain embodiments, the DIM+ pin may also be called as a DIM+ terminal, DIM+ input, DIM+ dimming control input terminal etc., which corresponds to the DIM+ dimming control signal. In conjunction with the DIM+ connection, the dimming control signal DIM− of the low-voltage dimmer (or 0-10V dimmer) 160 shown in FIG. 4 and FIG. 5, is connected to the DIM− pin of the dimmable LED driver circuit 140 located inside of the dimmable LED lamp through the remaining pin of pins 131-134 that is not involved in the AC Mains power supply or the DIM+ connections. In certain embodiments, the DIM− pin may also be called as a DIM− terminal, DIM− input, DIM− dimming control input terminal etc., which corresponds to the DIM− dimming control signal. It should be noted that the DIM+ and DIM− pins of the dimmable LED driver circuit 140 are respectively used to receive one or more output control signals or dimming control signals from the low-voltage dimmer (or 0-10V dimmer) 160 for dimming purposes. In this regard, the foregoing discussion discloses and describes an exemplary embodiment of the present invention. It is clear to those skilled in the art that the present disclosure teaches an electrical connection and interaction between a low-voltage dimmer and a dimmable LED driver, as well as the design and structure of a dimming control of the low-voltage dimmer, and the relationship and physical meaning of the corresponding DIM+ and DIM− pins of the dimmable LED driver circuit. With respect to the low-voltage dimmers (or 0-10V dimmers) 160, “DIM+” and “DIM-” represent output control signals or dimming control signals of a low-voltage dimmer (or 0-10V dimmer) 160, which are respectively transmitted or connected to the corresponding DIM+ and DIM− pins of the dimmable LED driver circuit 140, and through the said pins or terminals, the dimmable LED driver circuit 140 receives dimming control signals DIM+ and DIM− for providing dimming control. As an example, a DVST-WH low-voltage dimmer from Lutron and an XI020C056V054BST1M dimmable LED driver from Philips can be used. It will be apparent to those skilled in the art that other low-voltage dimmers and other dimmable LED drivers can also be used.

FIG. 7 shows a preferred embodiment according to the present disclosure. The AC power supply is introduced from one side (left end of FIG. 7) of the LED tube 100 and respectively connected to two pins 131 and 132 on the first end cap 121 of LED tube 100, The AC power supply is electrically connected to the power input terminal of the dimmable LED driver circuit 140 inside the LED tube 100 through the two pins 131 and 132, and the dimmable LED driver circuit 140 connects and drives the LED 150 (for example, one or more LEDs or LED strings). Advantageously, the DIM+ and DIM− pins of the dimmable LED driver circuit 140 inside the LED tube 100, are respectively connected to the two pins 133 and 134 on the second end cap 122 (the right end of FIG. 7), through the internal wiring of the LED tube 100. When the LED tube 100 is mounted into a pair of sockets (for example, an ANSI C82.62 standard socket for a T8 tube), the two pins 133 and 134, through the electrical connection and mechanical connection to the socket, are connected to the low-voltage dimmer (or 0-10V dimmer) 160 through any available connection such as building control wiring, such that the DIM+ and DIM− connections, or dimming control signals, can be provided to the dimmable LED driver circuit 140 through these wires. In this embodiment, the end of the LED tube 100, where the AC power supply is connected through the pins 131 and 132, can be referred to as the “AC input end”. The opposite end of the LED tube 100, where the dimmable LED driver circuit 140 is connected through the two pins 133 and 134 to the low-voltage dimmer, can be referred to as the “dimming side”.

FIG. 8 shows a second embodiment according to the present disclosure. In this embodiment, the AC Mains power supply line (L) and neutral line (N) are respectively introduced from both ends of the LED tube 100 and connected to pin 131 on the first end cap 121, and pin 133 on the second end cap 122. The remaining DIM+ and DIM− connections of the dimmable LED driver circuit 140 are connected to the low-voltage dimmer (or 0-10V dimmer) 160 via the remaining pin 132 on the first end cap 121, and pin 134 on the second end cap 122 respectively. The connection of various components inside the LED tube 100 and the connection with the four pins can be seen in FIG. 8.

By applying the teachings from the present disclosure, existing fluorescent lamp installations are easily upgraded and remodeled using the existing lamp holders, sockets and lamp stands. Dimming function can be provided without the need of further modification of the LED tube 100, ends caps or lamp base (for example, drilling or opening of extra pin holes) for connecting to a low-voltage dimmer (or 0-10V dimmer) 160 for controlling the brightness of the LED 150. In addition, electrical connection to the low-voltage dimmer (or 0-10V dimmer) 160 is achieved through rewiring of existing standard sockets while further drilling or modifications are not required. Such electrical connections can easily conform to safety standards.

In addition, the LED tubes 100 as disclosed herein are not limited by the specific sizes and specifications. The exemplary LED tubes 100 may be other LED tubes satisfying the specific sizes and specifications as can be found in ANSI C78 a few of which are T2, T3.5, T4, T5, T8, T10 or T12. In addition, the examples of a dimmable LED driver circuit and a low-voltage dimmer are given above, but the embodiments of the present disclosure may include the use of other dimming control devices such as digital lighting control and as well as other dimmable driver circuits compatible with these additional dimming control devices.

In addition to the afore discussed LED tubes with two end caps located at both ends of the tube body (more commonly known as double ended lamp types), the present disclosure can also be applied to other LED replacement bulbs with one lamp base 211 and four pins passing through the lamp base 211 and fixed thereto. The LED replacement bulbs also conform to the physical sizes and dimensions of ANSI C78 single ended configurations and require two connections for power input and two connections for dimming control. The LED replacement bulbs can fit or mount into a socket which meet ANSI C81.62 standard. FIG. 10 is an exemplary LED light bulb or LED tube according to certain embodiments of the present disclosure, comprising a main body 210 (usually of the same physical dimensions of the fluorescent tube which was folded, bent, spiral shaped or otherwise made non-linear in form), a lamp base 211 located at one end of the main body 210 for covering the main body 210 and the dimmable driver circuit 140, four pins fixed on the lamp base 211 and one or more LEDs 150 located inside the main body 210 and connected to the dimmable LED driver circuit 140. The four pins are electrically connected to the dimmable LED driver circuit 140, and through the electrical connection and mechanical connection to a socket. As in the case described earlier in detail, two of the available pins are connected to AC Mains power supply and the remaining two pins are connected to the dimming control signal DIM+ and DIM−. In one embodiment, the dimming control signal, such as “low voltage dimming”, “electronic low voltage (ELV) dimming”, “1-10V dimming”, “0-10V dimming”, “DALI” or any other digital signal scheme, is provided by a dimming controller, which is a low-voltage dimmer, a digital control, a 0-10V dimmer, a part of an energy management or a building management system. The first pin and the second pin receive power input from an AC power supply, and the third pin and the fourth pin receive one or more dimming control signal. The one or more LEDs 150 are driven by the dimmable LED driver circuit 140.

FIG. 11 is the lamp base 221 of a 2G7 LED light bulb or a 2GX7 LED light bulb according to certain embodiments of the present disclosure. In this configuration, pins 231 and 234 are electrically connected to an AC power supply for receiving power input, and pins 232 and 233 are electrically connected to dimming control signal 260 for controlling the brightness of the one or more LEDs 150. It is apparent that in certain embodiments the connections of the four pins 231-234 can be swapped. For example, the AC power can be introduced from pins 232 and 233, and the low-voltage dimmer 260 can be connected to pins 231 and 234.

FIG. 12 is the lamp base 321 of a 2G10 LED light bulb or a 2G11 LED light bulb according to certain embodiments of the present disclosure. In this configuration, pins 331 and 334 are electrically connected to an AC power supply for receiving power input, and pins 332 and 333 are electrically connected to the dimming control signal 360 for controlling the brightness of the one or more LEDs 150. It is apparent that in certain embodiments the connections of the four pins 331-334 can be swapped. For example, the AC power can be introduced from pins 332 and 233, and the low-voltage dimmer 360 can be connected to pins 331 and 334.

FIG. 13 is the lamp base 421 of a GR10q LED square tube according to certain embodiments of the present disclosure. In this configuration, pins 431 and 434 are electrically connected to an AC power supply for receiving power input, and pins 432 and 433 are electrically connected to the dimming control signal 460 for controlling the brightness of the one or more LEDs 150. It is apparent that in certain embodiments the connections of the four pins 431-434 can be swapped. For example, the AC power can be introduced from pins 432 and 433, and the low-voltage dimmer 460 can be connected to pins 431 and 434.

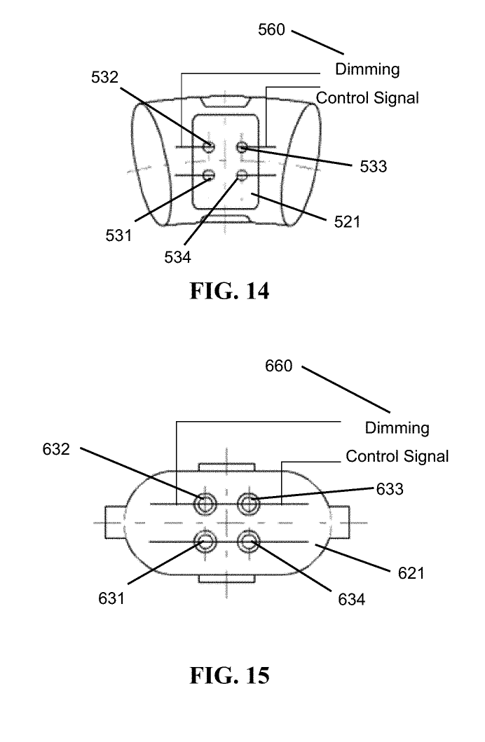

FIG. 14 is the lamp base 521 of a G10q LED circular tube according to certain embodiments of the present disclosure. In this configuration, pins 531 and 534 are electrically connected to an AC power supply for receiving power input, and pins 532 and 533 are electrically connected to the dimming control signal 560 for controlling the brightness of the one or more LEDs 150. It is apparent that in certain embodiments the connections of the four pins 531-534 can be swapped. For example, the AC power can be introduced from pins 532 and 533, and the low-voltage dimmer 560 can be connected to pins 531 and 534.

FIG. 15 is the lamp base 621 of a GX10q LED light bulb or a GY10q LED light bulb according to certain embodiments of the present disclosure In this configuration, pins 631 and 634 are electrically connected to an AC power supply for receiving power input, and pins 632 and 633 are electrically connected the dimming control signal 660 for controlling the brightness of the one or more LEDs 150. It is apparent that in certain embodiments the connections of the four pins 631-634 can be swapped. For example, the AC power can be introduced from pins 632 and 633, and the low-voltage dimmer 660 can be connected to pins 631 and 634.

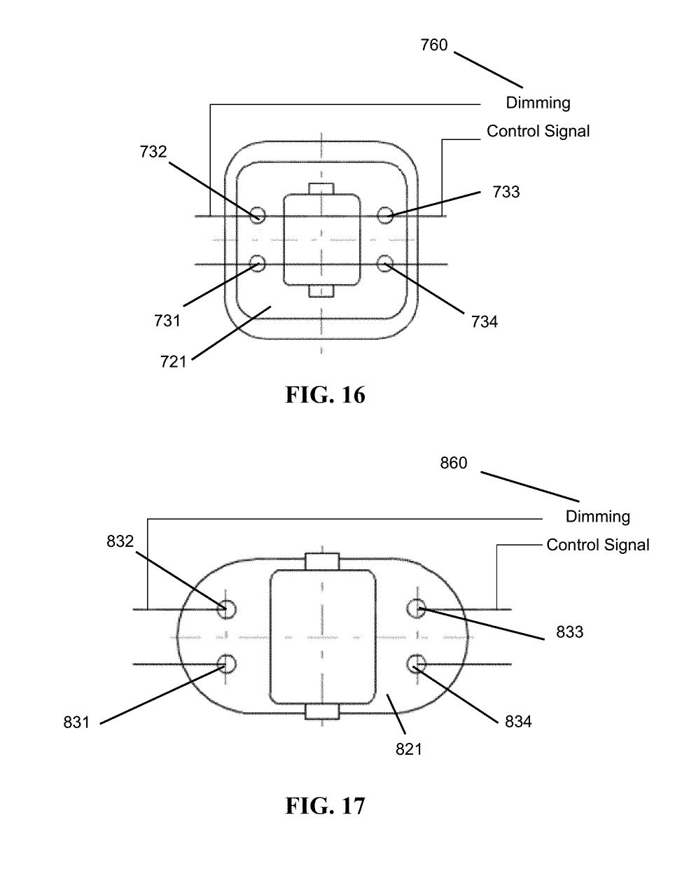

FIG. 16 is the lamp base 721 of a G24q LED light bulb or a GX24q LED light bulb according to certain embodiments of the present disclosure. In this configuration, pins 731 and 734 are electrically connected to an AC power supply for receiving power input, and pins 732 and 733 are electrically connected to the dimming control signal 760 for controlling the brightness of the one or more LEDs 150. It is apparent that in certain embodiments the connections of the four pins 731-734 can be swapped. For example, the AC power can be introduced from pins 732 and 733, and the low-voltage dimmer 760 can be connected to pins 731 and 734.

FIG. 17 is the lamp base 821 of a GX32q LED light bulb according to certain embodiments of the present disclosure. In this configuration, pins 831 and 834 are electrically connected to an AC power supply for receiving power input, and pins 832 and 833 are electrically connected to the dimming control signal 860 for controlling the brightness of the one or more LEDs 150. It is apparent that in certain embodiments the connections of the four pins 831-834 can be swapped. For example, the AC power can be introduced from pins 832 and 833, and the low-voltage dimmer 860 can be connected to pins 831 and 834.

While embodiments of the present invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An LED replacement lamp for replacing a conventional double-ended fluorescent lamp, the LED replacement lamp comprising:
a tube body;
one or more LEDs located inside the tube body;
a dimmable LED driver circuit located in the tube body;
two end caps located at two ends of the tube body longitudinally, wherein the two end caps comprise a first end cap and a second end cap for covering the tube body at the two ends respectively; and
four pins fixed on the two end caps and electrically connected to the dimmable LED driver, wherein the four pins comprise a first pin and a second pin for receiving power input from an AC power supply, and a third pin and a fourth pin for receiving one or more dimming control signals;
wherein:
the one or more LEDs are driven by the dimmable LED driver.

2. The LED replacement lamp according to claim 1, wherein the first pin and the second pin are on the first end cap, the third pin and the fourth pin are on the second end cap.

3. The LED replacement lamp according to claim 1, wherein the first pin and third pin are on the first end cap, and the second pin and the fourth pin are on the second end cap.

4. The LED replacement lamp according to claim 1, characterized in that the LED replacement lamp conforms to physical sizes and dimensions of ANSI C78 double ended configurations and requires two connections for power input and two connections for dimming control.

5. The LED replacement lamp according to claim 1, characterized in that the LED replacement lamp fits or mounts into lamp holders or sockets which meet ANSI C81.62 standards and requires two connections for power input and two connections for dimming control.

6. The LED replacement lamp according to claim 1, wherein the tube body is a T2, T3.5, T4, T5, T6, T8, T9, T10 or T12 tube.

7. The LED replacement lamp according to claim 1, wherein the tube body is a hollow cylindrical tube with a mechanical structure of the conventional double-ended fluorescent lamp.

8. An LED lighting system characterized in that the LED lighting system comprises:
the LED replacement lamp according to claim 1;
two sockets; and
a dimming controller configured to provide one or more dimming control signals to the LED replacement lamp for controlling the one or more LEDs.

9. The LED lighting system according to claim 8, wherein the one or more dimming control signals of the dimming controller are connected to the third pin and the fourth pin of the LED replacement lamp.

10. The LED lighting system according to claim 8, wherein the one or more dimming control signals of the dimming controller are connected to the third pin and the fourth pin through the two sockets.

11. The LED lighting system according to claim 8, wherein the two sockets conform to the ANSI C81.62 standard.

12. The LED lighting system according to claim 8, wherein the dimming controller is a 0-10V dimmer.

13. The LED lighting system according to claim 8, wherein the dimming controller is a digital control.

14. The LED lighting system according to claim 8, wherein the dimming controller is a part of an energy management or a building management system.

15. An LED replacement bulb for replacing a conventional single-ended bulb, the LED replacement bulb comprising:
a main body;
one or more LEDs located inside the main body;
a dimmable LED driver circuit located inside the main body;
a lamp base, located at one end of the main body, for covering the one end of the main body and the dimmable LED driver circuit;
four pins fixed to the lamp base and electrically connected to the dimmable LED driver circuit, wherein the four pins comprise a first pin and a second pin for receiving power input from an AC power supply, and a third pin and a fourth pin for receiving one or more dimming control signals;
wherein the one or more LEDs are driven by the dimmable LED driver.

16. The LED replacement bulb according to claim 15, wherein the LED light bulb is a 2G7 light bulb, a 2GX7 light bulb, a 2G10 LED light bulb, a 2G11 LED light bulb, a GR10q LED square tube, a G10q LED circular tube, a GX10q LED light bulb, a GY10q LED light bulb, a G24q LED light bulb, a GX24q LED light bulb, or a GX32q LED light bulb.

17. The LED replacement bulb according to claim 15, wherein the first pin and the second pin are on the left side of the lamp base, the third pin and the fourth pin are on the right side of the lamp base.

18. The LED replacement bulb according to claim 15, wherein the first pin and third pin are on the right side of the lamp base, and the second pin and the fourth pin are on the left side of the lamp base.

19. The LED replacement bulb according to claim 15 that conforms to the physical sizes and dimensions of ANSI C78 single ended configurations and require two connections for power input and two connections for dimming control.

20. The LED replacement bulb according to claim 15 that fits or mounts into a socket which meet ANSI C81.62 and require two connections for power input and two connections for dimming control.

21. An LED lighting system characterized in that the LED lighting system comprises:
the LED replacement bulb according to claim 15;
a socket; and
a dimming controller configured to provide one or more dimming control signals to the LED replacement bulb for controlling the one or more LEDs.

22. The LED lighting system according to claim 21, wherein the one or more dimming control signals of the dimming controller are connected to the third pin and the fourth pin of the LED replacement bulb.

23. The LED lighting system according to claim 21, wherein the one or more dimming control signals of the dimming controller are connected to the third pin and the fourth pin through the socket.

24. The LED lighting system according to claim 21, wherein the socket conforms to the ANSI C81.62 standard.

25. The LED lighting system according to claim 21, wherein the dimming controller is a 0-10V dimmer.

26. The LED lighting system according to claim 21, wherein the dimming controller is a digital control.

27. The LED lighting system according to claim 21, wherein the dimming controller is a part of an energy management or a building management system.
